(19) United States
(12) Patent Application Publication
(10) Pub. No.: US 2011/0119229 A1
(43) Pub. Date: May 19, 2011

(54) APPARATUS FOR CREATING WORKFLOW OF COMPOSITION WEB SERVICE AND FUNCTIONALITY INFORMATION CONSTRUCTION METHOD FOR CREATING WORKFLOW OF COMPOSITION WEB SERVICE

(75) Inventors: Yu-Chul JUNG, Daegu-si (KR); Sang-Ki KIM, Daejeon-si (KR); Byung-Sun LEE, Daejeon-si (KR)

(73) Assignee: Electronics and Telecommunications Research Institute, Daejeon (KR)

(21) Appl. No.: 12/847,579

(22) Filed: Jul. 30, 2010

(30) Foreign Application Priority Data
Nov. 16, 2009 (KR) 10-2009-0110459

(51) Int. Cl. G06F 17/00

(52) U.S. Cl. 707/608; 707/E17.008

(57) ABSTRACT

Provided are an apparatus for creating a workflow of a composition web service and a functionality information construction method for creating a workflow of a composition web service. The apparatus and method analyze procedural knowledge described in web documents to normalize and continuously accumulate functionality information required for performing a task, and automatically configure a workflow of a composition web service by combining pieces of the accumulated functionality information, thereby solving the problem of a discordance occurring when one composition web service is configured by dynamically combining multiple different web services.

### CROSS-REFERENCE TO RELATED APPLICATION

This application claims the benefit under 35 U.S.C. §119(a) of Korean Patent Application No. 10-2009-0110459, filed on Nov. 16, 2009, the disclosure of which is incorporated herein in its entirety by reference.

### BACKGROUND

1. Field

The following description relates to technology for automatically creating a workflow for a web service, and more particularly, to an apparatus for creating a workflow of a composition web service in which multiple web services are combined and a functionality information construction method for creating a workflow of a composition web service.

2. Description of the Related Art

With increasing use of web services, web service composition based on business process execution language (BPEL) is attracting attention in the field of semantic web service.

It is preferable for web services to be clearly described and combined, like the workflow of a domain providing a specific web service, but it is very difficult to predict a composition of required web services and combine the web services in all domains.

A workflow manually created in a web service domain accompanied by various requests of users is difficult to reuse and cannot be easily extended to another domain. Also, the current types and quantities of workflows are not sufficient. Consequently, research is necessary to solve these problems.

### SUMMARY

The following description relates to an apparatus that can normalize and accumulate functionality information required for performing a task by analyzing procedural knowledge described in a web document and create a workflow of a composition web service by combining pieces of the accumulated functionality information, and a functionality information construction method for creating a workflow of a composition web service.

According to an exemplary aspect, there is provided a functionality information construction for creating a workflow of a composition web service method. The functionality information construction method is as follows. First, a sentence in which information required for performing a task is recorded is obtained from a web document. An action for performing a task and a task performing object are extracted from the obtained sentence, and functionality information linking the extracted action and object is generated and selected. The selected functionality information is normalized to be accumulated. A plurality pieces of accumulated functionality information are combined to form a work flow of a composition web service including multiple web services combined with each other.

The present invention normalizes and accumulates functionality information required for performing a task by analyzing procedural knowledge described in continuously increasing web documents and automatically configures a workflow of a composition web service by combining pieces of the accumulated functionality information, thereby solving the problem of a discordance occurring when one composition web service is configured by dynamically combining multiple different web services.

Also, it is possible to reduce time and cost required for a conventional method of manually solving the problem of a discordance occurring when one composition web service is configured by dynamically combining multiple different web services.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of an apparatus for creating a workflow of a composition web service according to an exemplary embodiment of the present invention.

FIG. 2 shows an example of a screen in which only a text part is obtained from a web document.

FIG. 3 shows an example of a screen in which a sentence including an action and an object is extracted from an obtained sentence.

FIG. 4 illustrates an outline of selecting functionality information using a plurality of calculation models.

FIG. 5 shows an example of a screen in which a verb corresponding to an action is extracted.

FIG. 6 illustrates an example of an outline of normalizing selected functionality information.

FIG. 7 is a flowchart illustrating an example of a process of normalizing selected functionality information.

FIG. 8 shows an example of matching relationships between pieces of functionality information and workflows accumulated in a database.

FIG. 9 is a flowchart illustrating a functionality information construction method for creating a workflow of a composition web service according to an exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

With improvement in competitiveness based on business process innovation, business process management (BPM) is attracting attention. Workflow configuration that is the core of BPM analyzes, controls, and manages flow between target unit tasks and thus is very important for accurate and rapid task processing, effective information provision, real-time task control, and so on. Thus, business innovation can be achieved by systematic and continuous workflow evaluation and analysis.

Business process execution language (BPEL) is mainly aimed at combining several loosely linked web services to create a long running workflow and synthesizing the web services into one business application. In particular, since major vendors of Java 2 platform enterprise edition (J2EE) and .NET have actively supported BPEL, BPEL is superior to existing workflow languages in the aspect of providing language neutrality on the basis of extensible markup language (XML) and web services as well as a functional aspect.

Although BPEL is aimed at objects in an upper level and provides basic language elements for data manipulation and process flow, a BPEL-based composition is entirely dependent on manual operation of an expert and developer of the corresponding domain.

Also, even if a business process is manually created, the business process is not based on an intuitive and standard action. On the other hand, the business process tends to use respective information systems according to task characteristics and store information about task performance of the business process itself according to a format defined in each system.

These characteristics hinder business process extension to another domain and like process tracking in the corresponding domain. The problems should be solved to configure a more automatic and semantic BPEL-based composition.

Since mining of a business process described in BPEL is very limited in quantity, action mining is performed on the basis of a web document and a functionality-based workflow is created in an exemplary embodiment of the present invention when the workflow of a composition web service in which multiple web services are combined is configured.

An apparatus for creating a workflow of a composition web service according to an exemplary embodiment of the present invention normalizes and accumulates functionality information required for performing a task by analyzing procedural knowledge described in a web document, and configures a workflow of a composition web service by combining pieces of the accumulated functionality information.

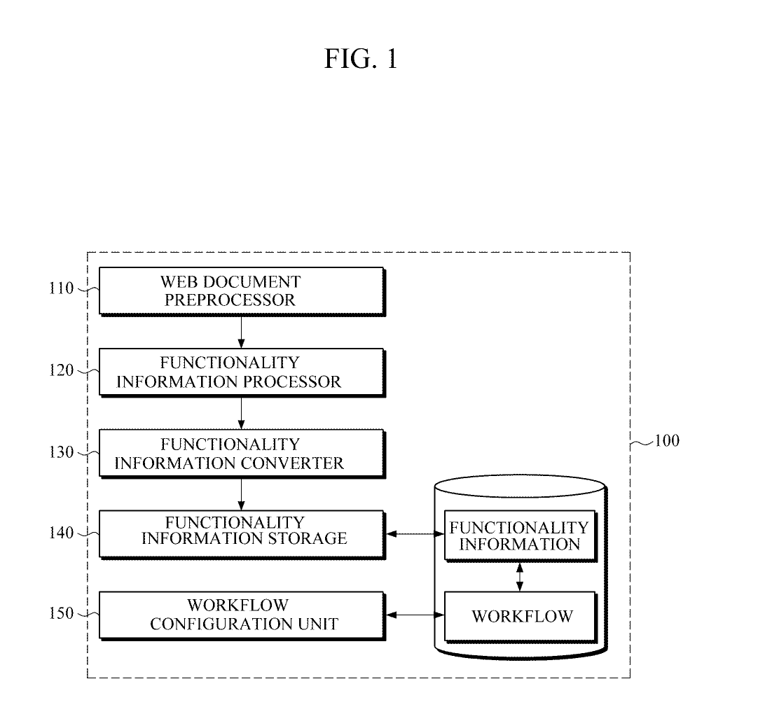

FIG. 1 is a block diagram of an apparatus for creating a workflow of a composition web service according to an exemplary embodiment of the present invention. As shown in FIG. 1, an apparatus 100 for creating a workflow of a composition web service according to this exemplary embodiment includes a web document preprocessor 110, a functionality information processor 120, a functionality information converter 130, a functionality information storage processor 140, and a workflow configuration unit 150.

The web document preprocessor 110 obtains a sentence in which information required for performing a task is recorded from a web document. Information can be obtained using websites, from which procedural knowledge input by people can be obtained, as the resource of a web document. In several websites based on Web 2.0, knowledge referred to as collective intelligence tends to continuously increase with the help of many participants.

Procedural knowledge required for various users to achieve desired goals, for example, how to get a discount while shopping, how to tie a necktie, how to fix a broken computer, how to travel in New York, how to find a girlfriend, and how to cook various dishes is accumulated by many experts/amateurs.

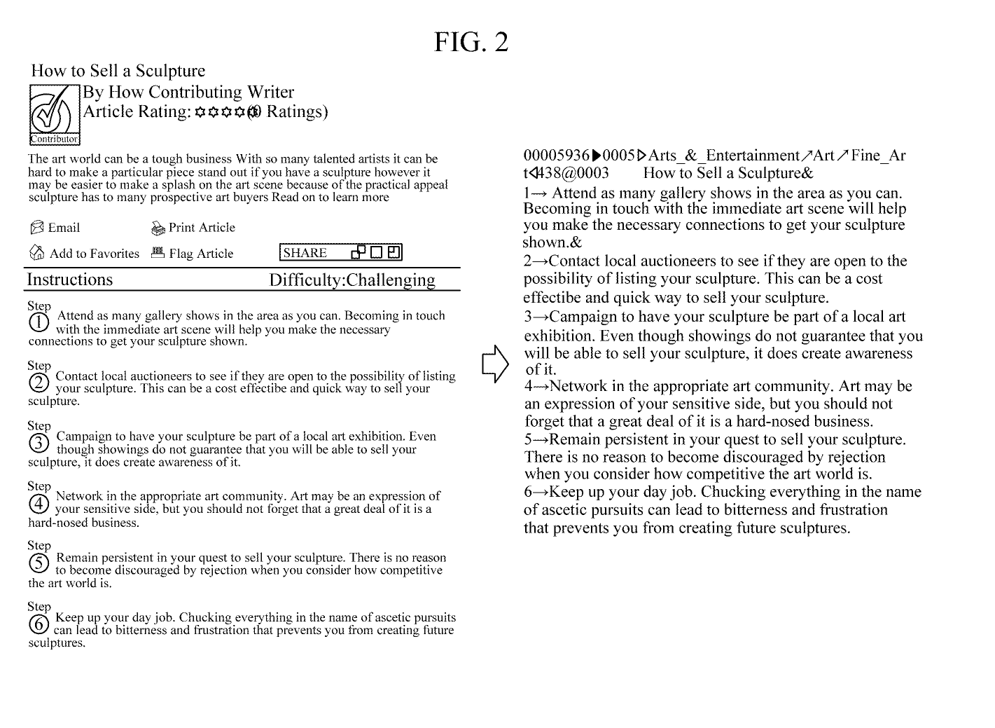

For example, by focused crawling, the web document preprocessor 110 can remove hypertext markup language (HTML) codes from a web document and obtain only a text part that contains procedural knowledge only required for performing a specific task. FIG. 2 shows an example of a screen in which only a text part is obtained from a web document. In FIG. 2, the left side shows a web page screen in which the web document is executed, and the right side shows a screen in which the text part obtained from the web document is displayed.

The functionality information processor 120 extracts an action for performing a task and a task performing object from the sentence obtained by the web document preprocessor 110, and generates and selects functionality information linking the extracted action and object.

For example, the functionality information processor 120 can extract a verb part that expresses an action and an ingredient part that expresses an object of the action from the sentence obtained by the web document preprocessor 110 by part-of-speech tagging and named entity tagging.

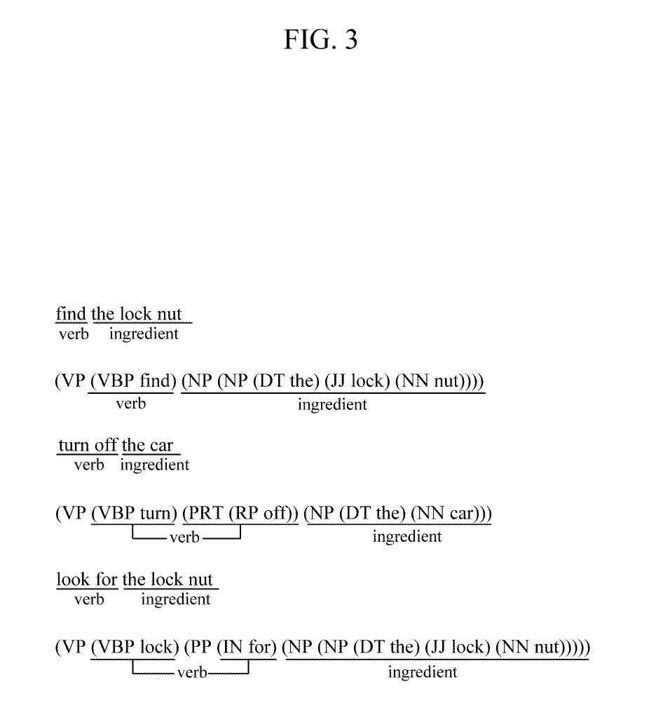

FIG. 3 shows an example of a screen in which a sentence including an action and an object is extracted from an obtained sentence. From the first sentence of FIG. 3, “find” that is a verb part expressing an action in the obtained sentence and “the lock nut” that is an ingredient part expressing an object of the action are extracted.

The functionality information converter 130 normalizes the functionality information selected by the functionality information processor 120. Procedural information required for performing a task is described differently in respective web documents. To reduce difference in differently described procedural knowledge and intuitively recognize a task performing procedure, the functionality information selected by the functionality information processor 120 is normalized by the functionality information converter 130.

For example, the functionality information converter can normalize an action and object included in functionality information linking the action and object into a highly frequent expression, that is, a generally used expression having a like meaning. At this time, the functionality information converter 130 can normalize the functionality information using a machine learning technique in which a previously learned normalization pattern model is referred to.

Thus, according to circumstances, the expression of the functionality information linking the extracted action and object may be maintained as is or changed into a totally different expression.

The functionality information storage processor 140 stores or updates the functionality information normalized by the functionality information converter 130 in a database to accumulate the normalized functionality information. In other words, the functionality information storage processor 140 newly adds the functionality information normalized by the functionality information converter 130 in a database, or updates existing functionality information.

The workflow configuration unit 150 combines pieces of normalized functionality information that is stored or updated and accumulated by the functionality information storage processor 140 to configure a workflow of a composition web service in which multiple web services are combined.

For example, the workflow configuration unit 150 configures multiple composition web service workflows, in which component web services are abstracted and combined, using an abstraction technique, and makes different pieces of functionality information correspond to the respective abstracted component web services so that a workflow of a composition web service can be automatically configured.

At this time, the workflow configuration unit 150 may combine different pieces of normalized functionality information according to domains provided with a composition web service to configure a workflow of the composition web service so that a user-adaptive workflow of the composition web service can be configured.

In this way, an exemplary embodiment of the present invention normalizes and continuously accumulates functionality information required for performing a task by analyzing procedural knowledge described in continuously increasing web documents, and automatically configures a workflow of a composition web service by combining pieces of the accumulated functionality information, thereby solving the problem of a discordance occurring when one composition web service is configured by dynamically combining multiple different web services.

Thus, it is possible to reduce time and cost required for a conventional method of manually solving the problem of a discordance occurring when one composition web service is configured by dynamically combining multiple different web services.

Meanwhile, according to an additional aspect of the present invention, the functionality information processor 120 may determine the suitability of generated functionality information and select the functionality information.

For example, the functionality information processor 120 may calculate the score of functionality information using at least one calculation model for suitability calculation and compare the calculated score with a threshold value to determine the suitability of the functionality information. The functionality information processor 120 may reflect a calculation-model-specific weight in score calculation.

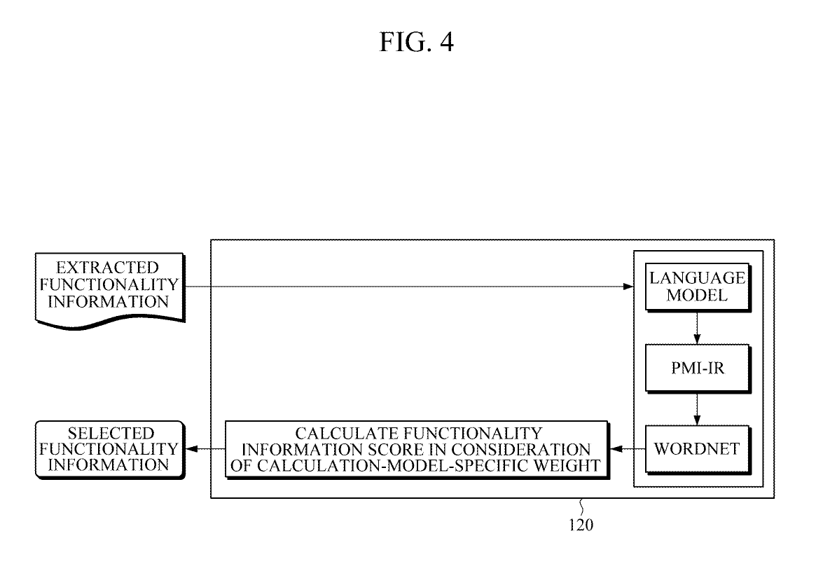

FIG. 4 illustrates an outline of selecting functionality information using a plurality of calculation models, that is, three calculation models of a language model, point-wise mutual information (PMI)-information retrieval (IR), and WordNet.

The functionality information processor 120 extracts an action for performing a task and a task performing object from a sentence obtained by the web document preprocessor 110, and generates functionality information linking the extracted action and object.

When the functionality information is generated, the functionality information processor 120 calculates relative importances that the action and object of the functionality information have using the language model. Equation 1 to Equation 4 are examples of equations for calculating relative importances that an action and object of functionality information have.

$$\begin{matrix}{W}_{phraseness} ( {V}_{i} , {E}_{ij} ) = P ( {LM}_{fg} ( {}_{}^{″}{V}{}_{i}^{} {E}_{ij}^{″} ) ) log ( \frac{P ( {LM}_{fg} ( {}_{}^{″}{V}{}_{i}^{} {E}_{ij}^{″} ) )}{P ( {LM}_{fg} ( {}_{}^{″}{V}{}_{i}^{″} ) )} ) & [ Equation 1 ] \\ {W}_{informativeness} ( {V}_{i} , {E}_{ij} ) = P ( {LM}_{fg} ( {}_{}^{″}{V}{}_{i}^{} {E}_{ij}^{″} ) ) log ( \frac{P ( {LM}_{fg} ( {}_{}^{″}{V}{}_{i}^{} {E}_{ij}^{″} ) )}{P ( {LM}_{bg} ( {}_{}^{″}{V}{}_{i}^{} {E}_{ij}^{″} ) )} ) & [ Equation 2 ] \\ {W}_{action} ( {V}_{i} , {E}_{ij} ) = {W}_{phraseness} ( {V}_{i} , {E}_{ij} ) + {W}_{informativeness} ( {V}_{i} , {E}_{ij} ) & [ Equation 3 ]\end{matrix}$$

In the above equations, Vᵢ denotes i-th action in a set of actions, Eᵢⱼ denotes a j-th object of Vᵢ, P(LM_{fg}(“Vᵢ Eᵢⱼ”)) denotes a probability of an action-object pair in the corresponding domain, P(LM_{fg}(“Vᵢ”)) denotes a probability of an action in the corresponding domain, and P(LM_{bg}(“Vᵢ Eᵢⱼ”)) denotes a probability of all action-object pairs.

Equation 1 and Equation 2 denote probabilities of a pair of words other than a separate word. Equation 1 denotes a probability in the corresponding domain, and Equation 2 denotes a probability that a pair of an action and object is remarkable in the corresponding domain relative to all domains. In Equation 3, the sum of Equation 1 and Equation 2 is defined as a relative importance.

Meanwhile, to select objects having like meanings from several object candidates, a set of like words is generated using WordNet, and only a noun phrase is obtained by part-of-speech tagging and phrase chunking.

After all words are extracted from each sentence, to obtain a synonym of the corresponding word, superordinates of the respective words are checked with reference to WordNet, and then a list of synonyms subordinate to the word is obtained.

This is because understanding a meaning on the basis of a word alone used in a text is not sufficient to understand a statistical value. According to circumstances, a substitute dictionary may be additionally built to process a synonym specialized for a domain (WordNet was built by linguists and thus includes few words of actual technology and engineering domains).

By part-of-speech tagging and phrase chunking, all but noun phrases are filtered, and noun phrases having a high statistical probability of appearance among the extracted noun phrases are filtered again. To this end, a score W_{object} of functionality information is obtained using, for example, a Google conditional probability (GCP) score. Equation 4 is an expression using PMI-IR, denoting semantic relatedness by a co-occurrence frequency between the corresponding action and object.

$${W}_{object} ( {V}_{i} , {E}_{ij} ) = \frac{Hits ( {}_{}^{″}{V}{}_{i}^{} , {E}_{ij}^{″} )}{Hits ( {}_{}^{″}{V}{}_{i}^{″} )} \qquad [ Equation 4 ]$$

In Equation 4, Hits(“Vᵢ Eᵢⱼ”) denotes the number of search operations obtained from a search engine using Vᵢ and Eᵢⱼ as search words, and Hits(“Vᵢ”) denotes the number of search operations obtained from a search engine using V, as a search word.

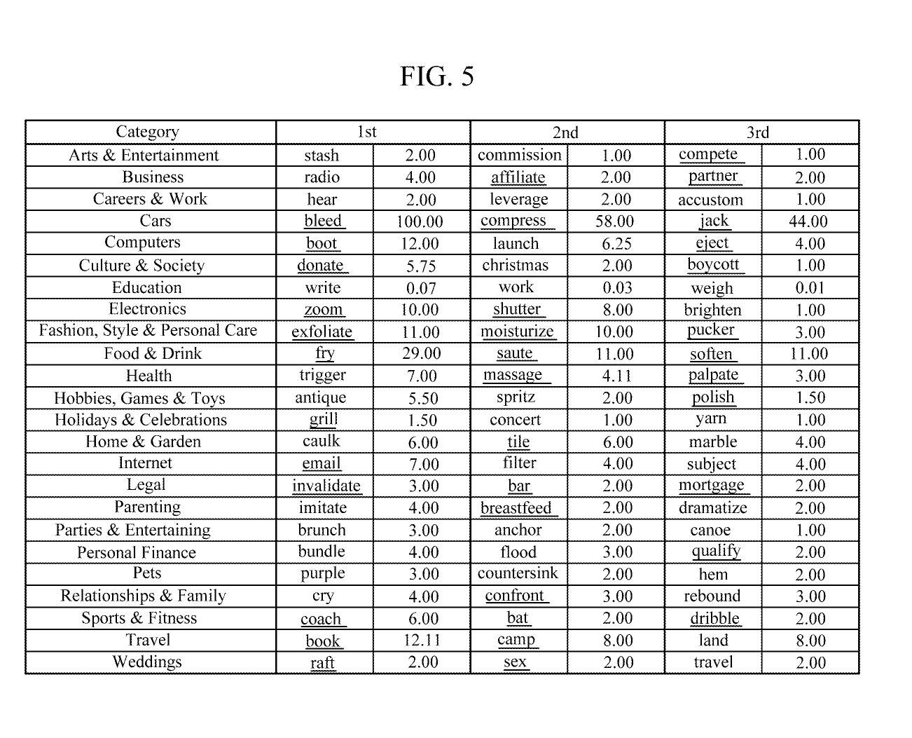

FIG. 5 shows an example of a screen in which a verb corresponding to an action is extracted. In this example, Equation 1 to Equation 3 are applied to extracting a verb corresponding to an action. Referring to FIG. 5, for example, in a “Travel” category, “book” is more important than others.

Scores of functionality information are calculated by Equation 3 in consideration of respective calculation-model-specific weights. Here, the calculated scores are arranged in decreasing order and compared with a threshold value, and functionality information having a score greater than the threshold value is selected to determine the suitability of the functionality information.

Meanwhile, according to an additional aspect of the present invention, the functionality information converter 130 may determine the validity of normalized functionality information.

For example, the functionality information converter 130 may determine the validity of normalized functionality information using a previously learned normalization pattern model. Also, the functionality information converter 130 may determine a normalization level and class of normalized functionality information.

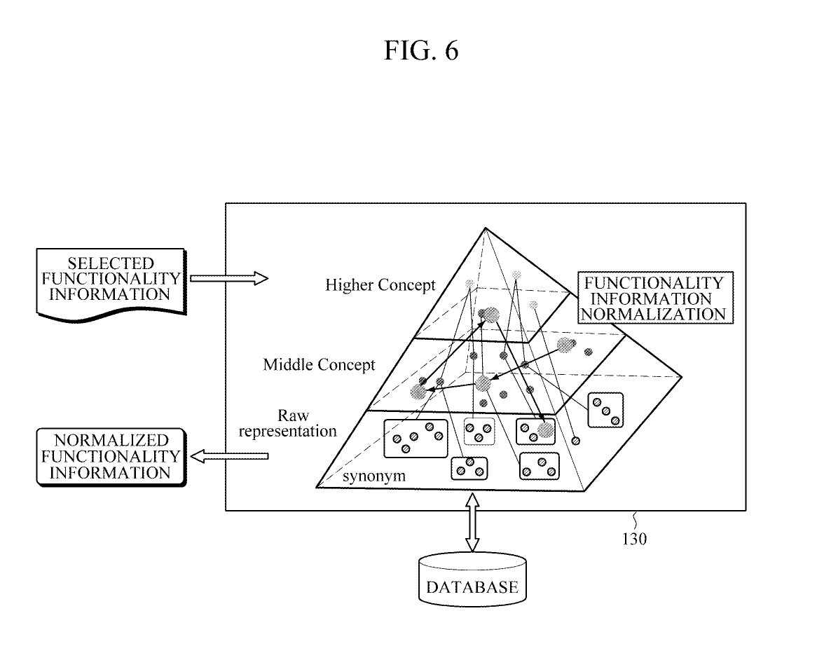

FIG. 6 illustrates an example of an outline of normalizing selected functionality information. The functionality information converter 130 normalizes functionality information selected by the functionality information processor 120. In other words, the functionality information converter 130 normalizes a pair of an action and object of the selected functionality information in comparison with pairs of an action and object of functionality information and a workflow existing in the same or like task with reference to a database, and determines the normalization level and task class of the functionality information.

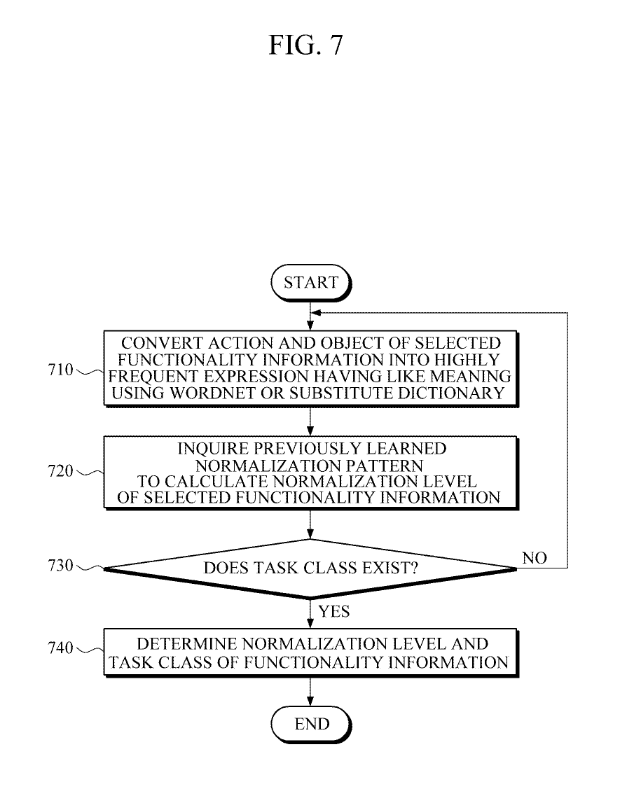

FIG. 7 is a flowchart illustrating an example of a process of normalizing selected functionality information. First, in operation 710, an action and object of selected functionality information are converted into a highly frequent expression having a like meaning using WordNet or a substitute dictionary. This is intended to remove ambiguity when a level for normalized functionality information is determined, and to facilitate comparison with a previously learned normalization pattern.

With enlargement in the corresponding domain and application range of a substitute dictionary, the substitute dictionary needs to be additionally expanded. Here, the substitute dictionary can be expanded on the basis of functionality information included in a lately extended workflow with reference to a database.

When an action and object of the selected functionality information are converted into a highly frequent expression having a like meaning, a previously learned normalization pattern is inquired to calculate the normalization level of the normalized functionality information in operation 720, and it is determined in operation 730 whether a task class exists.

Assuming that a normalization pattern has been learned in advance using a maximum entropy model, the action and object of the functionality information are compared with the previously learned normalization pattern. And then, only when the score of the functionality information is an experimental threshold value or more, is a normalization level determined.

The maximum entropy model has the most uniform distribution among probability distributions satisfying a given condition, and is used to find y that satisfies a conditional probability p(y|x) as much as possible. Here, x denotes functionality information in each workflow, and y denotes the class of a task.

Thus, multiple pieces of functionality information for each task are used as training data to optimize the maximum entropy model. When k pieces of functionality information are input, a conditional probability is expressed by Equation 5 below.

$$p ( y \vert x ) = \frac{1}{Z} exp ( {\sum }_{k = 1}^{K} {λ}_{k} {f}_{k} ( y , x ) ) \qquad [ Equation 5 ]$$

In Equation 5, k denotes the number of pieces of functionality information, fₖ denotes a k-th piece of functionality information, and λₖ denotes a weight for each piece of functionality information in the maximum entropy model. Z denotes a normalization factor satisfying Σp(y|x)=1. In addition to the maximum entropy model, a conditional random field may be used as another machine learning technique.

A learned normalization pattern that is previously stored in a database can be used to classify a normalization level and task class of newly input functionality information. When newly input functionality information does not satisfy an appropriate normalization level, a remarkably low degree of task class relation is output as a result.

In this case, the process proceeds back to operation 710, which converts an action and object of the selected functionality information into a highly frequent expression having a like meaning, to select words of the next order as an action and object of the functionality information. Then, a previously learned normalization pattern is inquired to calculate the normalization level of the normalized functionality information in operation 720, and it is determined in operation 730 whether a task class exists.

When the changed functionality information satisfies the appropriate normalization level and task class, the normalization level and task class of the functionality information is determined in operation 740, and it is determined whether the functionality information storage processor 140 stores or updates the functionality information normalized by the functionality information converter 130 in a database. When the changed functionality information is totally new functionality information or modified functionality information, the changed functionality information is newly added to the database, or existing functionality information is updated.

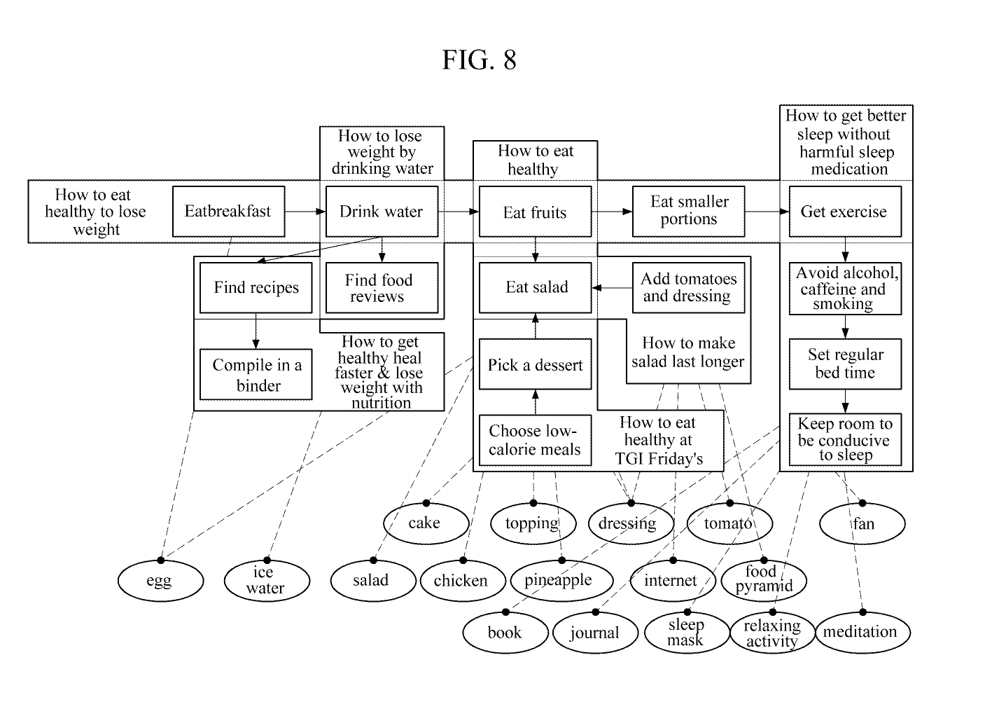

FIG. 8 shows an example of matching relationships between pieces of functionality information and workflows accumulated in a database. Referring to FIG. 8, workflows share similar functionality information in the middle, and it can be checked what functionality information is shared by different workflows. For example, functionality information “egg” in the lower left portion of FIG. 8 is shared by “Eat breakfast” and “Pick a dessert.”

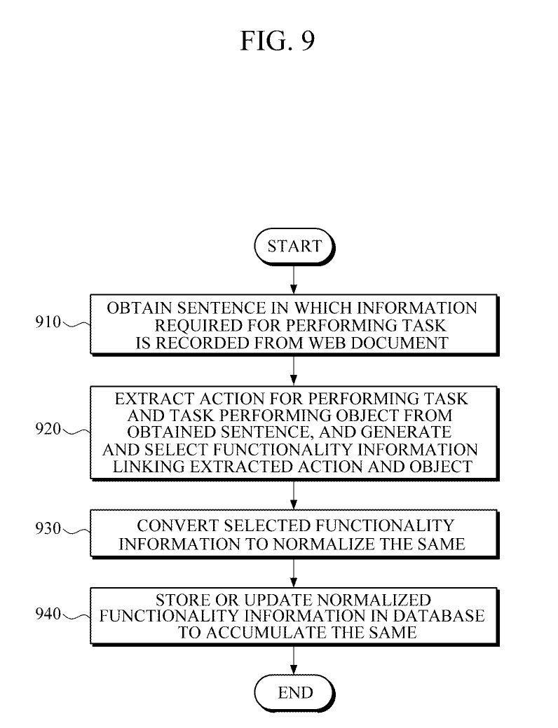

A process in which an apparatus for creating a workflow of a composition web service according to an exemplary embodiment of the present invention constructs functionality information for creating a workflow of a composition web service will be described below with reference to FIG. 9. FIG. 9 is a flowchart illustrating a functionality information construction method for creating a workflow of a composition web service according to an exemplary embodiment of the present invention.

As illustrated in FIG. 9, in this functionality information construction method for creating a workflow of a composition web service according to an exemplary embodiment of the present invention, the apparatus for creating a workflow of a composition web service obtains a sentence in which information required for performing a task is recorded from a web document in operation 910. Since obtaining a sentence in which information required for performing a task is recorded from a web document has been described above, the description will not be reiterated.

In operation 920, the apparatus for creating a workflow of a composition web service extracts an action for performing the task and a task performing object from the sentence obtained in operation 910, and generates and selects functionality information linking the extracted action and object.

At this time, the suitability of the functionality information generated in operation 920 may be determined to select the functionality information. For example, the score of the functionality information is calculated using at least one calculation model for suitability calculation, and the calculated score is compared with a threshold value to determine the suitability of the functionality information. Meanwhile, a calculation-model-specific weight may be reflected in score calculation. Since generating and selecting functionality information linking an extracted action and object has been described above, the description will not be reiterated.

In operation 930, the apparatus for creating a workflow of a composition web service normalizes the functionality information selected in operation 920. At this time, the action and object included in the functionality information linking the extracted action and object can be normalized into a highly frequent expression having a like meaning.

Meanwhile, in operation 930, the validity of the normalized functionality information may be determined. For example, the validity of the normalized functionality information can be determined using a previously learned normalization pattern model.

Also, in operation 930, the normalization level and task class of the normalized functionality information may be determined. Since normalizing selected functionality information, determining the validity of normalized functionality information, determining the normalization level and task class of normalized functionality information have been described above, the description will not be reiterated.

In operation 940, the apparatus for creating a workflow of a composition web service stores or updates the functionality information normalized in operation 930 in a database to accumulate the functionality information. Thus, by analyzing procedural knowledge described in continuously increasing web documents, it is possible to normalize and continuously accumulate functionality information required for performing a task, and the apparatus for creating a workflow of a composition web service according to an exemplary embodiment of the present invention combines pieces of the accumulated functionality information to automatically configure a workflow of a composition web service.

As described above, an exemplary embodiment of the present invention analyzes procedural knowledge described in continuously increasing web documents to normalize and continuously accumulate functionality information required for performing a task, and automatically configures a workflow of a composition web service by combining pieces of the accumulated functionality information, thereby solving the problem of a discordance occurring when one composition web service is configured by dynamically combining multiple different web services.

Accordingly, it is possible to reduce time and cost required for a conventional method of manually solving the problem of a discordance occurring when one composition web service is configured by dynamically combining multiple different web services, and the above mentioned purpose of the present invention can be achieved.

An exemplary embodiment of the present invention can be used in the fields of workflow creation technology and application technology of the same.

The exemplary embodiments of the present invention can also be embodied as computer-readable codes on a computer-readable recording medium. Codes and code segments constituting the programs can be easily deduced by computer programmers skilled in the art. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can also be distributed over network connected computer systems so that the computer-readable code is stored and executed in a distributed fashion.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An apparatus for creating a workflow of a composition web service, comprising:
a web document preprocessor obtaining a sentence in which information required for performing a task is recorded from a web document;
a functionality information processor extracting an action for performing a task and a task performing object from the sentence obtained by the web document preprocessor, and generating and selecting functionality information linking the extracted action and object;
a functionality information converter normalizing the functionality information selected by the functionality information processor;
a functionality information storage processor storing or updating the functionality information normalized by the functionality information in a database to accumulate the normalized functionality information; and
a workflow configuration unit combining pieces of the normalized functionality information stored or updated and accumulated by the functionality information storage processor to configure a workflow of a composition web service in which multiple web services are combined.

2. The apparatus of claim 1, wherein the functionality information processor determines suitability of the generated functionality information to select the functionality information.

3. The apparatus of claim 2, wherein the functionality information processor calculates a score of the functionality information using at least one calculation model for suitability calculation, and compares the calculated score with a threshold value to determine suitability of the functionality information.

4. The apparatus of claim 3, wherein the functionality information processor reflects a calculation-model-specific weight in score calculation.

5. The apparatus of claim 1, wherein the functionality information converter normalizes the action and object included in the functionality information linking the action and object into a highly frequent expression having a like meaning.

6. The apparatus of claim 5, wherein the functionality information converter determines validity of the normalized functionality information.

7. The apparatus of claim 6, wherein the functionality information converter determines the validity of the normalized functionality information using a previously learned normalization pattern model.

8. The apparatus of claim 5, wherein the functionality information converter determines a normalization level and task class of the normalized functionality information.

9. The apparatus of claim 1, wherein the workflow configuration unit combines different pieces of the normalized functionality information according to domains provided with the composition web service to configure the workflow of the composition web service.

10. A functionality information construction method for creating a workflow of a composition web service, comprising:
obtaining a sentence in which information required for performing a task is recorded from a web document;
extracting an action for performing a task and a task performing object from the obtained sentence, and generating and selecting functionality information linking the extracted action and object;
normalizing the selected functionality information; and
storing or updating the normalized functionality information in a database to accumulate the normalized functionality information.

11. The functionality information construction method of claim 10, wherein the generating and selecting of the functionality information linking the extracted action and object includes determining suitability of the generated functionality information to select the functionality information.

12. The functionality information construction method of claim 11, wherein the generating and selecting of the functionality information linking the extracted action and object further includes calculating a score of the functionality information using at least one calculation model for suitability calculation, and comparing the calculated score with a threshold value to determine the suitability of the functionality information.

13. The functionality information construction method of claim 12, wherein the generating and selecting of the functionality information linking the extracted action and object further includes reflecting a calculation-model-specific weight in score calculation.

14. The functionality information construction method of claim 10, wherein the normalizing of the selected functionality information includes normalizing the action and object included in the functionality information linking the action and object into a highly frequent expression having a like meaning.

15. The functionality information construction method of claim 14, wherein the normalizing of the selected functionality information further includes determining validity of the normalized functionality information.

16. The functionality information construction method of claim 15, wherein the normalizing of the selected functionality information further includes determining the validity of the normalized functionality information using a previously learned normalization pattern model.

17. The functionality information construction method of claim 14, wherein the normalizing of the selected functionality information further includes determining a normalization level and task class of the normalized functionality information.
